(19) United States
(12) Patent Application Publication
(10) Pub. No.: US 2007/0079884 A1
(43) Pub. Date: Apr. 12, 2007

(54) Heat shrunk double wall, self-insulating, lightweight duct

(75) Inventors: Reg Tomerlin, Los Angeles, CA (US); David S. Larner, Fountain Valley, CA (US); Kathy Jun, Cerritos, CA (US)

Correspondence Address: Vern Schooley;Fulwider Patton Lee & Utecht, LLP, Suite 1550, 200 Oceangate, Long Beach, CA, 90802, US

(73) Assignee: Arrowhead Products Corporation

(21) Appl. No.: 11/248,103

(22) Filed: Oct. 12, 2005

(51) Int. Cl. F16L 11/00

(52) U.S. Cl. 138/112; 138/125; 138/148

(57) ABSTRACT

A dual wall duct constructed of heat resistant polymer, a reinforcing cord interposed between the inner and outer tube and the outer tube heat shrunk on the inner to form an annulus for entrapment for thermally insulated gas such as air.

### FIELD OF THE INVENTION

The present invention relates to a very lightweight duct for circulating air to or from specified locations within a common carrier.

### BACKGROUND OF THE INVENTION

1. Description of the Prior Art

Common carriers such as aircraft, automobiles, naval vessels and trains require the circulation of air and gases within specific areas for controlling the environment and the exhausting heat exhaust gases. To accomplish such circulation, many vehicles use ducts to carry and circulate the gas from one area to another. The use of ducts to circulate gas is commonly known as an environmental control system (“ECS”). Our particular challenging task is the flow of hot air from jet engine bypasses. Using duct systems for this purpose can be very convenient yet has it own drawbacks.

It has long been recognized that lightweight ducting is desirable for aircraft usage. In recognition of this problem it has proposed to construct dual wall metallic ducting having convolutions spaced along the length of the other tubing. Ducting of this type is shown in U.S. Pat. No. 3,960,343 to Thompson.

At present, construction of most ducts for these purposes vary from rigid to flexible construction. Most ducts are produced out of flexible metallic material such as aluminum or flame resistant non-metallic material. To serve their purpose, it is important the ducts insulate the fluid being transferred from the environment. To achieve thermal insulation of the duct systems, insulation blankets are frequently wrapped around the ducts. The vast majority of insulation blankets are composed of fiberglass, which are covered by polymeric materials that meet high flammability standards.

The problem with the ducts of the present is the weight associated with the insulation blankets. These insulation blankets contribute as much as 15 to 20% of the weight of the ECS duct system. The weight associated with the insulation blankets are undesirable and can be thought of as a parasitic factor in the overall design of the ECS and the common carrier.

Another problem with ducts that use insulation blankets is the time consuming effort of manufacture and installation. Ducts are typically installed about the time assembly of the common carrier frame is nearing completion. This presents a two-fold problem. The first is that the ducts must be inspected both before and after the insulation is installed. The second problem stems from efforts to conceal the ducts and their structures with the insulation blankets. By covering the ducts, the insulation blankets make it difficult not only to visually inspect ducts, but also to spot any damage or flaws in the ducts. This slows the process for identifying ducts in need of repair or replacement since insulation blankets must be removed and replaced whenever a duct is suspected of being damaged.

Efforts to produce thin wall tubing has focused to a great degree on metallic tubing or the wrapping of thin polyester films. Examples are in U.S. Pat. No. 2,954,803 to Barnes, U.S. Pat. No. 4,299,641 to Kelly and U.S. Pat. No. 6,152,186 to Arney. Metallic tubing suffer the shortcoming that it has a relatively high specific gravity and polyester film does not exhibit the weight, fire and chafe resistance preferable for aerospace applications.

It has been proposed to construct ducts from helically wrapped strips of foam thermoplastic rubber. A device of this type is shown in U.S. Pat. No. 6,729,296. Such ducts, while having utility for general ducting work, suffer the shortcoming that the rubber material does not meet the specifications for aerospace applications and are typically relatively heavy and do not incorporate effective thermal barriers.

In effort to provide thermal barriers, it has been proposed to incorporate thin wall metal foil layers separated by a corrugated thermoplastic resin film. A device of this type is shown in U.S. Pat. No. 3,655,502 to Yoshikawa. Again devices of this type again add unwanted weight.

Small diameter convoluted polyetherether keytone ETFE or PEEK has been proposed for biological applications and for gas analysis such as chromatography. To applicant's knowledge, it has not been used in this film form in dual wall ducts such as thermally insulated air exhausts.

In unrelated areas such as for cryogenic fluid transfer. It has been known to construct dual wall metallic ducts configured with an annulus between a pair of tubes and within which a partial vacuum may be drawn to provide a thermal barrier to heat transfer between the inside and outside of the duct. Such vacuum jacket construction is not generally acceptable for use even in aerospace vehicles as the dual wall metal construction adds significantly to the overall weight and it would be prohibitively expensive to construct the ducting to maintain an effective vacuum and to hold that vacuum. Thus, a need exists in the marketplace for a duct that is lightweight and self-insulating while maintaining flexibility and high flammability standards. Aspects of the present invention fulfils this need.

### SUMMARY OF THE INVENTION

Briefly and in general terms, the present invention is directed to a lightweight duct used to transfer fluid to specified areas in a common carrier. The duct includes tubular walls that form an annulus to trap a thermally insulating gas therein. The walls that form the duct may be made from polymeric materials and may be reinforced by a helical cord. In one preferred embodiment, the material used to form the walls is a polymide, such as Kapton® or polyetherether ketone film. The outer tube, formed of material with a memory, is slid over the inner tube and heated to be shrunk thereon. We have discovered that by employing an extremely thin film of PEEK or a similar polymer and reinforcing the inner tube, our duct can withstand the high temperatures and high flow rates associated with even exhaust gas bypassed from jet engines. The film used to form the inner wall of the duct may be as thin as 0.0005 inches. A film used to form the outer wall may be as thin as 0.00025 inches. By heating the outer tube to a selected degree it can be shrunk radially onto the reinforced inner tube to the point where it traps the reinforcing cord in place and diminishes the annulus between the inner and outer wall to a selected radial thickness necessary to present the thermal barrier desired for the particular application.

To provide support and shape for the duct, a reinforcing cord may be placed within the two walls that allows for flexibility of movement while maintaining the overall tubular form. In one preferred embodiment, the cord is wound helically about the inner wall. The cord may be of any flexible solid materials that can provide stable shape yet flexibility to the duct. In one preferred embodiment, the cord may be hollow and made from a lightweight and high temperature resistant material such as polyethersulfone or polyetherether ketone. Hollow cords such as these provide lesser weight and create better insulation because of their shape and the internal cavities they possess. In another embodiment, the cord may be a solid material such as steel wire. In one preferred embodiment, the cord is attached to the inner wall of the duct by adhesive bonding where the adhesive is highly temperature resistant. Other embodiments may fix the cord between the inner tube and outer tube by using friction.

In order to maximize the efficiency of gas circulation, the duct may also encompass other embodiments that assist in providing thermal insulation and environmental control. In one embodiment, the inner surface of the inner wall may be coated with a thin reflective surface. Such a surface may reflect radiated heat back into a flow stream in such inner tube adding to the efficiency of the construction. . Such inner surface may also be formed with a low frictional finish to minimize flow resistance.. In another preferred embodiment, the reflective surface is aluminum.

These and other features and advantages of the duct will become apparent from the following detailed description of preferred embodiments which, taken in conjunction with the accompanying drawings, illustrate by way of example the principles of the invention.

### BRIEF DESCRIPTION OF THE DRAWINGS

FIG. 1 is a perspective view of a film being wrapped on a mandrel to form an inner tube that may be incorporated in the duct of the present invention;

FIG. 2 is a partial sectional view, in enlarged scale, taken along the line 2-2 of FIG. 1;

FIG. 3 is a partial sectional view similar to FIG. 2 with a vapor deposit of reflective metal added;

FIG. 4 is a perspective view similar to FIG. 1 showing a reinforcing cord being wrapped about the inner tube;

FIG. 5 is a transverse sectional view, in enlarged scale taken along the lines 5-5 of FIG. 1;

FIG. 6 is a transverse sectional view taken along the lines 6-6 of FIG. 4;

FIG. 7 in a partial longitudinal sectional view, in enlarged scale of an inner tube reinforced by a cord as shown in FIG. 4;

FIG. 8 is a detailed sectional view, in enlarged view, taken from the circle designated 8 in FIG. 7; and

FIG. 9 is a perspective view of a shrink tube being extruded on a mandrel to be employed in a third embodiment of the present invention;

FIG. 10 is a longitudinal sectional view, in enlarged scale, of the shrink tube of FIG. 9 telescoped over a reinforced inner tube;

FIG. 11 is a sectional view similar to FIG. 10 but with the outer tube shrunk into place; and

FIG. 12 is a longitudinal section view in reduced scale, lengths of the ducts as shown in FIG. 11 coupled together by bell fittings.

### DETAILED DESCRIPTION OF THE INVENTION

The lightweight self-insulated duct device of the present invention includes, concentric inner and outer tubes 21 and 23 constructed of an ultra thin flame resistant polymer such as polyetherether keytone. The walls cooperate to form therebetween an annulus 25 housing a helical reinforcing element, generally designated 27, which may also be constructed as a polymer such as polyethersulfone and, in the preferred embodiment, also serves as a radial spacer for establishing the radial thickness of the annulus 25. The outer tube 23 is formed by stretching it to a diameter substantially larger than that of the wrapped inner tube so it can be conveniently telescoped there over. Heat may then be applied to shrink it into position as shown in FIG. 10 to constrain the cord and inner tube while trapping air in the annulus 25.

Commercial aircraft have typically utilized flexible and rigid ducts of varying diameters and configuration for circulating air within cabin and for cooling various components such as electronic racks exhausting heat gases as from a bypass from a jet engine. These ducts have often been made of metallic and non metallic materials. For thermal insulation, it is have been common practice to wrap the ducts with fiber glass insulation with a thin film of polymeric material such as to meet the high flammability standard set forth in FAA Regulation FAAR 25.856. These blankets may weigh as much as 15% to 20% of the weight of the entire Environmental Condition System (ECS) ducting. This weight is parasitic and contributes nothing to the structure of the ducting itself. It is the purpose of the present invention to provide a lighter weight efficient ducting construction which will meet the high standards set forth in the industry and be economical to manufacture.

The tubes 21 and 23 may be constructed of various thin flame resistant polymeric materials which are gas impermeable and of relatively lightweight film such as polyetherether keytone sold under the trademark Kapton® or chemically analogous films such as PBI (polybenzimizole). The inner wall 21 will typically have thickness of 0.0004 inches to 0.0010 inches but preferably about 0.0005 inches. To provide some degree of rigidity and reinforcement for the film wall of the inner tube 21 is preferably wound with a reinforcing cord 27 which may be constructed of polyethersulfone and may be constructed with a solid or hollow cross section as the application may demand.

The outer tube 25 is a little thinner than the inner tube, possibly only half the thickness of the inner wall such as, for instance, between 0.00020 and 0.00030, and preferably, 0.00025 inches. It will be appreciated that with the tubes formed with even a relatively radial thin annulus, as for instance 0.100 inches thick, the helically wound reinforcement cord 27 will cooperate to minimize circulation of the air in the dead space provided by the annulus thus minimizing any tendency of the air in the annulus to provide for dynamic transfer of heat between the inner and outer tubes due to air circulation. To immobilize the reinforcing cord 27 it may be trapped frictionally between the tubes or may be bonded to either the inner or outer tubes 21 or 23 or to both as shown in FIG. 10. One adhesive found effective is NuSil Sil R32-2186 available from NuSil Technology.

As will be appreciated by those skilled in the art the radial thickness of the annulus 25 may be increased or decreased by merely increasing or decreasing the cross sectional of the cord 27 to the diameter for the cord 35. The cord may thus be between about 0.040 and 0.200, and preferably 0.100 inches in cross section. In the present example, the cord is shown with a round cross section but, as will be apparent to those skilled in the art, may take many different shapes such as square, oval or rectangular.

In practice, the radially inner surface of the inner tube 21 is coated by a optically reflective coating, such as for example vapor deposited aluminum 31 to a thickness of about 300 angstroms to reflect a major portion of any heat radiated in fluid flowing through the duct back into the air flow to thus conserve against loss of the corresponding energy. Preferably, this layer of aluminum provides a high polish finish to minimize friction and reduce the resistance to air flow through the duct.

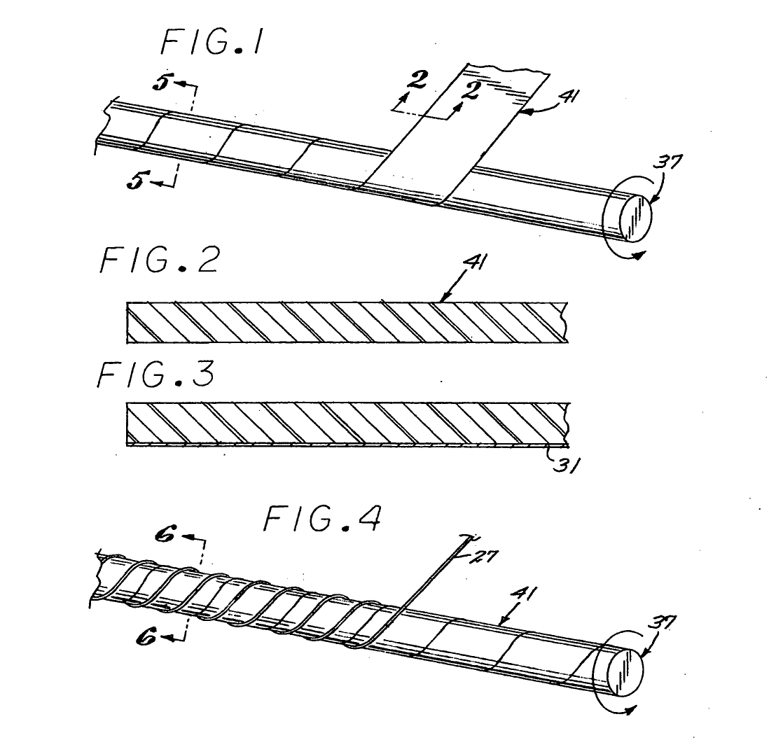

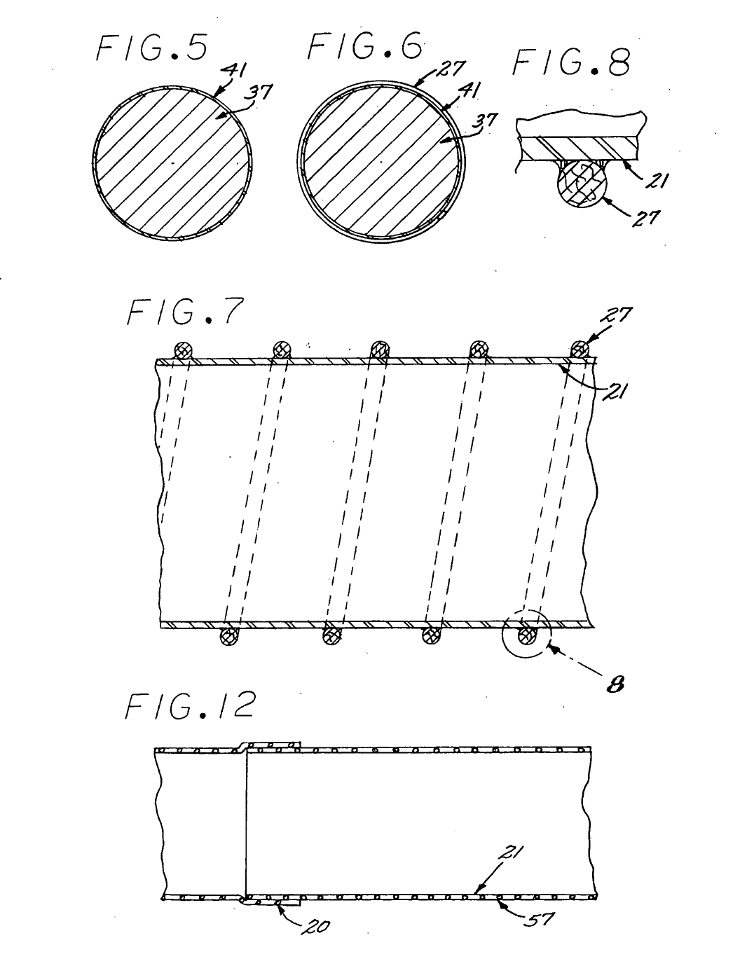

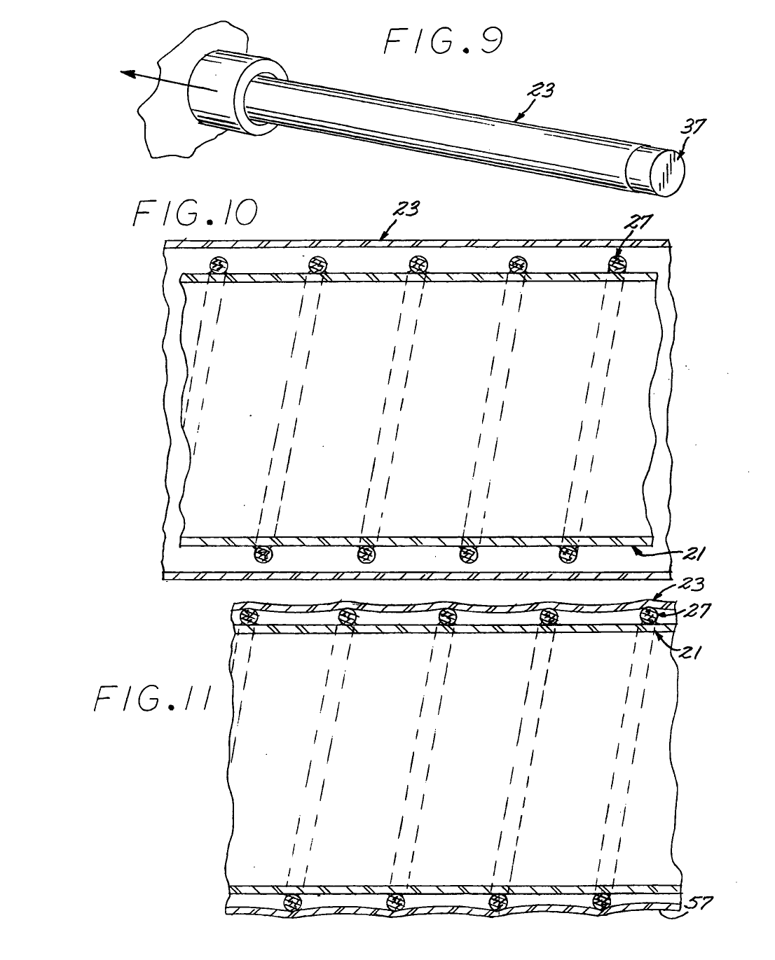

A convenient method of making the tubes 21 and or 23 is to wind a length of thin polyetherether ketone film (PEEK) on a mandrel 37 as shown in FIG. 1. For gas applications, the mandrel will typically have a diameter of between 3 and 7 inches or more depending on the expected volume of flow. The film strip 41 may be fed onto the mandrel 37 as it is rotated about its own longitudinal axis to wind the strip thereon in a helical pattern to form tube wall as shown in FIG. 6. In one embodiment the opposite edges of film strip 41 are coated with an adhesive and are fed onto the mandrel 37 to cause such edges to overlap to adhere the adjacent helix together. In some embodiments, the interior surface of the strip, at least the part other than the marginal edges, is coated with the 300 angstrom thick vacuum deposited aluminum to create the aluminum surface film 31 (FIG. 3) to afford a smooth low friction and friction reflective surface.

After winding of the film strip 41, with or without the reflective surface 31, the cord 27 may be wound onto the mandrel 37 as shown in FIG. 4 about the helices of the strip 41 with possibly a 2 to 1 pitch.

Thereafter, a PEEK strip of film 0.00025 inches thick, with adhesive under the opposite edges, may be wound helically about a mandrel of a diameter larger than that of the mandrel 37 to fabricate exterior outside tube 23. Once the adhesive on the opposite marginal edge of the strip has cured the outer tube may be extruded from the mandrel and stretched radially to the diameter shown in FIG. 10. Thereafter, such tube may be telescoped over the reinforced inner tube and heat applied thereto reinforced at a sufficient temperature and for a sufficient period of time to shrink such tube radially inwardly to embrace the cord and inner tube and to trap air between the respective helices of the cord at a radial thickness dictated by the cross section of the cord and the extent of radially inward contraction between the helices of the cord to provide the desired barrier to heat transfer from the inner tube.

Once the adhesive at the edge of the film strip and, if applicable, on the cord, has cured, the dual walled tubing may be extruded from the mandrel 37 and the opposite ends thereof attach to or formed with fittings or couplings is, for instance male and female bell fittings, generally designated 20, (FIG. 12) which will be adaptable for connecting together in any desirable fashion. In some embodiments, one of the other or both of the tubes may be formed with convolutions, either circumferential or helical to thus add to the structural rigidity in the radial direction and afford flexibility to flex off from the longitudinal axis.

It will be appreciated that the present invention will provide a relatively light weight insulated duct which can be easily formed to different lengths for threading through the passage ways of the various commons carriers such as trains, boats, airplanes and even space vehicles and will pass the most stringent specifications for flammability, smoke and toxicity. The product is chafe-resistant and highly damage tolerant possessing resistance to corrosion thus eliminating the need for coating with oxidation resistant coatings and paints.

Referring to FIG. 9 in other preferred embodiments the inner and outer or both tubes may be constructed from PEEK tubing 51 extruded on a mandrel 53. It will also be appreciated that in other modifications the film will be provided in blanket form and rolled about a mandrel in cigarette paper fashion to form the desired cross section configuration with the longitudinal seam being sealed by an adhesive.

With the construction described, it will be appreciated that a craftsman can readily determine the configuration diameter and length, for instance, diameters of round 3 to 7″ inches and lengths of several feet which might be required in an application such as, for instance, exhaust of bypass air from a jet engine. It is desirable to limit the rate of heat transfer from such hot air to the interior of the air craft to thus avoid upsetting the environmental temperature. It will be appreciated that for whatever configuration selected, whether for straight runs, elbows, Y's or the like, the desired configuration mandrel might be provided such that the relatively thin wall tubes can be conveniently formed and the reinforcing cord interposed therebetween to define the annulus. The various lengths of the dual wall duct may have female fittings 20 formed in one end thereof to receive the male end of an adjacent length as shown in FIG. 12.

The ducts may be formed on jigs and fixtures to thus provide the desired end configuration, it being appreciated that some flexibility will be allowed for fitting through predetermined paths within the framework of the vehicle. The end fittings may then be coupled to, for instance, on one end to the bypass outlet and on the other end to an exhaust fitting such that, in practice, hot air will be conducted there through the inner tube and flowed along the smooth surface of the interior thereof with minimal pressure drop. The air entrapped within the annulus will afford a thermal barrier against transfer of heat from the ducting to the surrounding environment thus providing a efficient, practical and light weight means for exhausting such hot air, all the while providing the resistance to flammability and emissions of toxins in the event of a flame necessary to meet the high standards set for aircraft usage. The cord can be selected with the cross section necessary to provide the radial thickness of trapped air blanket to afford the desired thermal barrier.

From the foregoing, it will be apparent that a dual wall lightweight self insulating heat shrunk polymer duct of the present invention provides an economical and convenient means for fabricating a plane of chafe resistant duct to provide the desired level of thermal insulations in flowing gases such as air through the framework of a common carrier.

We claim:

1. An ultra light duct for flowing fluid to or from a specified location in a common carrier and comprising:
a first flame resistant, gas impermeable polymeric film configured to form an inner tube;
a reinforcing cord wrapped helically about the inner tube;
a second flame resistant, gas impermeable polymeric film configured to form an outer tube surrounding the inner tube and heat shrunk about the cord and cooperating therewith to form an annulus; and
a thermally insulating gas trapped in the annulus.

2. The ultra light duct of claim 1 wherein:
at least one of the inner and outer tubes are in the form of a helically wrapped strip of film.

3. The ultra light duct of claim 1 wherein:
the inside surface of the inner tube is coated with an optically reflective material.

4. The ultra light duct of claim 1 wherein:
the inside surface of the inner tube is coated to form a low friction inner surface.

5. The ultra light duct of claim 1 wherein:
the outer tube is constructed with a wall thickness of substantially 0.00025 inches.

6. The ultra light duct of claim 1 wherein:
the inner tuber is constructed with a wall thickness of substantially 0.0005 inches.

7. The ultra light duct of claim 1 wherein:
the cord is constructed of polyethersulfone.

8. The ultra light duct of claim 1 wherein:
the gas filling the annulus is air.

9. The ultra light duct of claim 1 wherein:
the outer tube is constructed of helically wound round polyetherether.

10. The ultra light duct of claim 1 wherein:
the outer tube is constructed of polyetherether ketone.

11. The ultra light duct of claim 1 wherein:
the inner and outer tubes are constructed of helically wound polymeric strips.

12. The ultra light duct of claim 1 wherein:
the cord is trapped between the inner and outer tubes by friction.

13. The ultra light duct of claim 1 wherein:
the cord is affixed to at least one of the tubes by adhesive.

14. The ultra light duct of claim 1 wherein:
the inner and outer tubes cooperate to form the annulus having an annular thickness of substantially 0.0005 inches.

15. The ultra light duct of claim 1 wherein:
the outer surface of the inner tube is coated with vapor deposited aluminum having a thickness of substantially 300 angstroms.

16. The ultra light duct of claim 1 wherein:
the thermally insulating gas is at atmosphere pressure.

17. An ultra light duct comprising:
polymeric inner and outer tubes constructed of a polymeric film and cooperating to form therebetween an annulus;
reinforcement means in the annulus and constraining the inner tube against radial expansion;
the outer tube being heat shrunk onto the reinforcing means;
insulative means in the annulus;
a thermally insulative gas means in the annulus for insulating against transfer of heat between the inner and outer tubes.

18. A method of constructing an ultra light duct including:
wrapping a first flame resistant, gas impermeable polymeric film around a mandrel to form an inner tube;
wrapping a reinforcing cord means around the first tube;
forming an outer tube of a flame resistant, go impermeable polymeric film to be telescoped over the inner tube,
telescoping the outer tube on the inner tube;
applying heat to the outer tube to shrink it downwardly onto the reinforcing cord to cooperate with the inner tube to form an annulus and trap a thermally insulative gas in the annulus; and
separating the tubes from the mandrel.

19. A method of constructing an ultra light duct comprising:
wrapping a first polymeric film around a mandrel to form an inner tube;
wrapping a cord around the inner tube;
placing a polymeric heat shrink tube around the cord and first polymeric film;
heat shrinking the heat shrink tube around the cord and inner tube to affix the cord against the inner tube and to cooperate with the inner tube to form an annulus;
extruding the duct from the mandrel and;
depositing a coat of optically reflective material onto an inner surface of the inner tube.

20. An ultra light bypass exhaust duct for exhausting hot gas from a jet engine bypass and comprising:
a first PEEK film substantially 0.0005 inches thick helically wrapped and with helix thereof adhered together to form an elongated inner tube;
a second PEEK film substantially 0.00025 inches thick and configured to form an elongated outer tube heat shrunk around the inner tube and cooperating therewith to form an annulus;
a hollow, reinforcing cord made of polyethersulfone and wrapped helically about the inner tube and cooperating to form a spacer between the inner and outer tubes;
a adhesive affixing the cord to the inner tube; and
a thermally insulating gas trapped in the annulus to form a thermal barrier against transfer of heat from the exhaust gases flowing through the inner tube.
